(19) United States
(12) Patent Application Publication
(10) Pub. No.: US 2007/0136198 A1
(43) Pub. Date: Jun. 14, 2007

(54) Method of facilitating the tracing and/or auditing of operations performed during check image processing

(75) Inventors: Thomas J. Foth, Trumbull, CT (US); Michael Augello, Newport, RI (US); Jeffrey D. Pierce, Sandy Hook, CT (US); Brian M. Romansky, Monroe, CT (US); Kolleen Dibble-Smith, Redding, CT (US)

Correspondence Address: PITNEY BOWES INC.;35 WATERVIEW DRIVE, P.O. BOX 3000, MSC 26-22, SHELTON, CT, 06484-8000, US

(73) Assignee: Pitney Bowes Incorporated, Stamford, CT (US)

(21) Appl. No.: 11/302,814

(22) Filed: Dec. 14, 2005

(51) Int. Cl. G06Q 40/00

(52) U.S. Cl. 705/44

(57) ABSTRACT

A number of methods of processing checks are provided that enable the various parties involved in processing/clearing the checks to be able to audit the movement of the check, and specifically an image of the check, through the check processing/clearing system. In particular, cryptographic techniques are employed allow the various parties involved in processing/clearing the checks to be able to identify what person and/or process performed an operation on the check, such as scanning the check to create the check image or performing optical character recognition on the check image to obtain data therefrom such as the amount of the

### FIELD OF THE INVENTION

The present invention relates to check image processing, and in particular to a method for facilitating the tracing and/or auditing of operations performed during the processing of check images.

### BACKGROUND OF THE INVENTION

Traditionally, businesses have deposited checks received from, for example, customers by physically taking them to a branch of their bank and depositing them over the counter with a teller or dropping them into a night deposit box. The actual physical presentation of checks to be deposited was necessary because, under prior banking laws, the depository bank had to present the original of each check to the corresponding paying bank in order to clear the check. This changed in October of 2004 with the enactment of The Check Clearing for the 21^{st} Century Act, commonly referred to Check 21. Check 21 removed the legal requirement that an original paper check had to be presented to obtain payment. Instead, banks can now use digital images to transport check data from the bank of first deposit to the paying bank. If the paying bank cannot process a check image, the image can be printed, according to certain specifications, to create what is known as a substitute check, which is the legal equivalent of the original paper check. Check 21 has thus opened the door for remote check deposit solutions wherein check images, rather than original paper checks, are used to make deposits, thereby enabling businesses to eliminate trips to the bank. In addition, the use of check images also reduces check transportation costs among banks and improves funds availability.

As will be appreciated, a number of operations are performed on a check image as it moves through the check processing/clearing system from the time it is first created and transmitted for deposit to the time it reaches the bank on which it is drawn. It is desirable for the various parties involved in processing/clearing the check to be able to audit the movement of the check image through the system and, in particular, to be able to identify what person and/or process performed an operation such as scanning the check to create the check image or performing optical character recognition on the check image to obtain data therefrom such as the amount of the check. Thus, there is a need for a method or methods for facilitating the tracing and/or auditing of operations performed during the processing/clearing of check images.

### SUMMARY OF THE INVENTION

The present invention relates to a method of processing a check using a check processing device prior to, for example, electronically depositing the check. The method includes receiving authentication information, such as a PIN, token or biometric information, from an operator of the device, receiving amount information indicating an amount of the check from the operator, and creating a check image file that includes an electronic image of the check. The method further includes adding at least the authentication information, the amount information, and, optionally operator identifying information, to the check image file as embedded data to create a new check image file, and creating a signed check image file that includes the new check image file and a digital signature of the new check image file created using a private key, such as a private key specific to the operator or the device. The method may then further include transmitting the signed check image file to an upstream processor, such as a bank of first deposit.

The method may also further include creating a signed deposit file that includes a deposit file and a digital signature thereof, wherein the digital signature of the deposit file is created using the same private key. The deposit file includes the signed check image file for the check and one or more additional signed check image files for one or more additional checks.

In an alternative embodiment, the present invention relates to a method of processing a plurality of checks using a check processing device prior to, for example, electronically depositing the checks. The method includes receiving authentication information from an operator of the device and creating a signed amount file, wherein the signed amount file includes an amount file and a digital signature thereof created using a private key, such as a private key specific to the operator or the device, and wherein the amount file includes amount information for each of the checks received from the operator. Next, a check image file is created for each of the checks that includes an electronic image of the check. At least the authentication information is then added to each of the check image files as embedded data to create a respective new check image file for each of the checks. The method then further includes creating a signed check image file for each new check image file, wherein each signed check image file includes the new check image file and a digital signature thereof created using a private key. Finally, the method includes creating a signed deposit file that includes the signed amount file, each of the signed check files and a digital signature of the signed amount file and each of the signed check files that is created using the private key.

The invention also relates to a method of processing a check at an upstream location, preferably after it has been processed by one of the above methods. For example, the upstream location may be a bank of first deposit. The method includes receiving a check image file that includes an electronic image of the check and amount information indicating an amount of the check, and performing OCR on the electronic image using an OCR process to obtain an OCR amount for the check, wherein the OCR amount has a confidence score assigned by the OCR process. If the confidence score exceeds a predetermined threshold level or if the OCR amount matches the amount information, the method further includes (i) adding the OCR amount to the check image file as embedded data to create a first new check image file, and (ii) creating a first new signed check image file that includes the first new check image file and a digital signature of the first new check image file created using a private key specific to the OCR process. If, however, the confidence score does not exceed the predetermined threshold level and if the OCR amount does not match the amount information, the method further includes (i) adding second amount information that is read by an operator to the check image file as embedded data to create a second new check image file, and (ii) creating a second new signed check image file that includes the second new check image file and a digital signature of the second new check image file created using a private key specific to the operator.

In an alternative embodiment, the invention relates to a method of processing a check at an upstream location that includes receiving a deposit file that includes an amount file and a plurality of check image files preferably created as described in one embodiment above. The amount file includes a plurality of amounts corresponding to a plurality of checks being deposited, wherein the check is one of the plurality of checks. The check image files include a check image file for the check that includes an electronic image of the check. The method further includes performing OCR on the electronic image using an OCR process to obtain an OCR amount for the check that has a confidence score assigned thereto. If the confidence score exceeds a predetermined threshold level, the method includes (i) adding the OCR amount to the check image file as embedded data to create a first new check image file, and (ii) creating a first new signed check image file that includes the first new check image file and a digital signature thereof created using a private key specific to the OCR process. If the confidence score does not exceed the predetermined threshold level but a second OCR amount having a second confidence score exceeding the predetermined threshold level can be obtained by re-performing OCR on the electronic image using the OCR process and one of the amounts as a hint, the method includes (i) adding the second OCR amount to the check image file as embedded data to create a second new check image file, and (ii) creating a second new signed check image file that includes the second new check image file and a digital signature thereof created using the private key specific to the OCR process. If, however, the confidence score does not exceed the predetermined threshold level and if a second OCR amount having a second confidence score exceeding the predetermined threshold level cannot be obtained, then the method includes (i) adding second amount information read by an operator to the check image file as embedded data to create a third new check image file, and (ii) creating a third new signed check image file that includes the third new check image file and a digital signature thereof created using a private key specific to the operator.

Finally, the invention relates to a method of processing a check at an upstream location, preferably after the check was previously processed by another upstream processor such as a bank of first deposit. The method includes receiving a check image file that includes an electronic image of the check and amount data indicating an amount of the check, and determining whether the amount data is to be trusted using information associated with the check image file and one or more pre-defined rules. If it is determined that the amount data is to be trusted, the method includes using the amount data to process the check. If, however, it is determined that the amount data is not to be trusted, the method includes performing OCR on the electronic image to obtain an OCR amount and using the OCR amount to process the check. The amount data may have been generated by an OCR process or an operator, in which cases the information associated with the check image file relates to an identity of the OCR process or the operator, as appropriate. In addition, the check image file may be part of a signed check image file including a digital signature created using a private key of the OCR process or the operator, as appropriate. In this case, the information associated with the check image file that is used to determine whether the amount data is to be trusted may include the public key that corresponds to the private key.

Therefore, it should now be apparent that the invention substantially achieves all the above aspects and advantages. Additional aspects and advantages of the invention will be set forth in the description that follows, and in part will be obvious from the description, or may be learned by practice of the invention. Moreover, the aspects and advantages of the invention may be realized and obtained by means of the instrumentalities and combinations particularly pointed out in the appended claims.

### BRIEF DESCRIPTION OF THE DRAWINGS

The accompanying drawings illustrate presently preferred embodiments of the invention, and together with the general description given above and the detailed description given below, serve to explain the principles of the invention. As shown throughout the drawings, like reference numerals designate like or corresponding parts.

FIG. 1 is a flowchart showing a method of processing one or more checks before electronically sending the checks to an upstream processor, such as a bank of first deposit, according to one embodiment of the present invention;

FIG. 2 is a flowchart of a method for processing one or more checks before electronically transmitting the checks to an upstream processor, such as a bank of first deposit, according to an alternate embodiment of the present invention;

FIG. 3 is a flowchart showing a method of processing one or more checks before the checks are electronically transmitted to an upstream processor, such as a bank of first deposit, according to yet a further alternative embodiment of the present invention;

FIGS. 4A, 4B and 4C are flowcharts of a method of further processing the checks that were processed according to the methods shown in FIGS. 1 and 2;

FIGS. 5A, 5B and 5C are flowcharts showing a method for processing checks by an upstream processor such as a bank of first deposit when a plurality of checks have been previously processed according to the method shown in FIG. 3; and

FIG. 6 is a flowchart showing a method of processing a check image file, as created in the methods shown in FIGS. 4A, 4B and 4c or 5A, 5B, and 5C.

### DESCRIPTION OF THE PREFERRED EMBODIMENTS

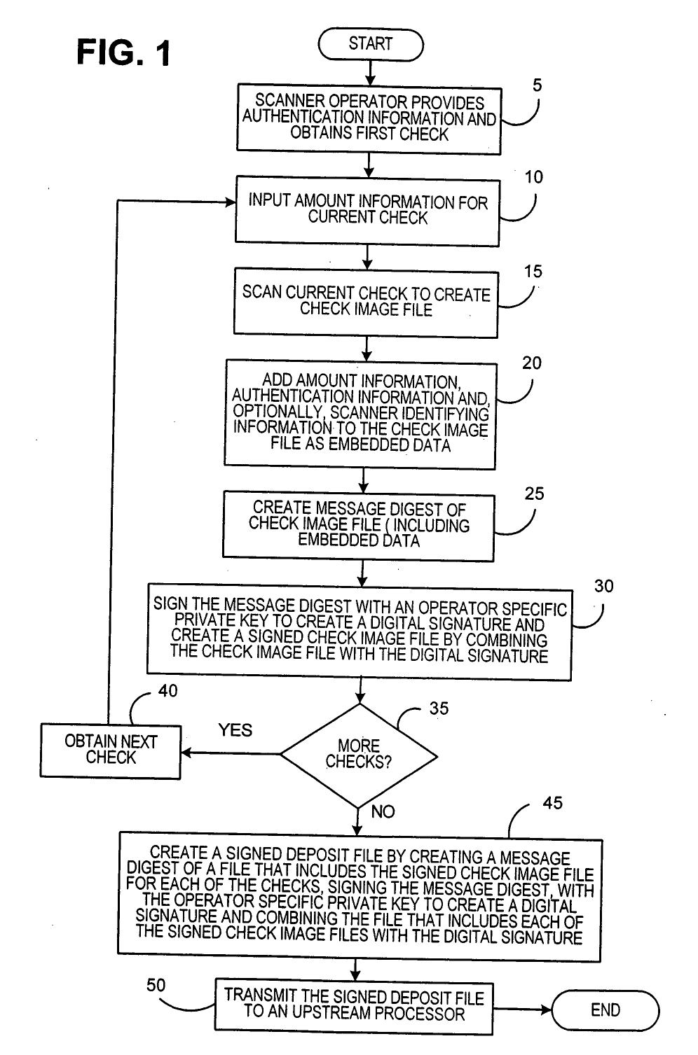

FIG. 1 is a flowchart showing a method of processing one or more checks before electronically sending the checks to an upstream processor, such as a bank of first deposit for depositing the checks, according to one embodiment of the present invention. The method shown in FIG. 1 contemplates the use of a scanning device that includes a processing unit, a memory and a digital scanner, wherein the device is specifically designed or adapted, typically through software additions or modifications, to provide the functionality of the method described herein. A number of suitable scanning devices (that may be adapted as described herein) are known and commercially available and may include, for example, the TS220E scanner sold by Digital Check Corporation of Northfield Ill.

The method begins at step 5, where an operator of a the scanning device at a first location, such as a location of a party depositing one or more checks, provides authentication information unique to that operator to the scanning device, such as through a keyboard or other input device, and obtains the first check to be processed. The authentication information is any type of information that may be used to uniquely identify the device operator, such as, without limitation, a personal identification number (PIN), a token or biometric information such as a fingerprint or retinal scan. Next, at step 10, the operator inputs information indicating the amount for the current check into the scanning device, which in this case is the first check to be processed. At step 15, the current check is scanned using the digital scanner to create a check image file (as used herein, the term “file” shall refer to a collection of data, such as may form an electronic image) in any one of a number of different known electronic image formats. Then, at step 20, the amount information that was input by the operator, the authentication information that was input by the operator, and, optionally, information identifying the scanning device, such as the serial number thereof, is added to the check image file as embedded data by the scanning device. As another option, MICR line information read by the scanning device may be added to the check image file as embedded data. Such embedded data may include, for example, data tags that are added to an image file such as a JPEG file. As will be appreciated, such embedded data does not get displayed as part of the image, but instead is data that becomes linked with the image and that may be later obtained therefrom.

Next, at step 25, a message digest of the check image file, including the embedded data, which was created in step 20 is created. The message digest may be any type of known digest or hash, such as an MD5 digest. At step 30, a signed check image file is then created. In particular, the signed check image file is created by signing (encrypting) the message digest with an operator specific private key to create a digital signature and combining the check image file with the digital signature in a data file. The data file may also include a public key certificate having the public key that corresponds to the specific private key issued by a public key infrastructure or another key certification authority. Preferably, each operator of the scanning device has his or her own private key that is stored in a vault or the like and released as a result of the provision of the authentication information in step 5. The private keys may be stored on the scanning device itself in secure memory, or, preferably, they may be stored remotely from the scanning device, in which case the private keys are maintained by a key management system and are provided to the scanning device as needed. Alternatively, the private key used in step 30 could be a private key assigned to the particular scanning device being used.

At step 35, a determination is made as to whether there are more checks that need to be processed. If the answer is yes, then at step 40, the next check is obtained and the method returns to step 10 and the check is processed as described above. If, however, the answer at step 35 is no, meaning that all of the checks to be processed have indeed been processed, then the method proceeds to step 45. In step 45, a signed deposit file is created by (i) creating a message digest, such as an MD5 digest, of a file that contains the signed check image file for each of the checks, (ii) signing (encrypting) the message digest with the operator specific private key to create a digital signature, and (iii) combining the file that includes each of the signed check image files with the digital signature in a data file (which may also include the public key certificate). Then, at step 50, the signed deposit file is electronically transmitted to an upstream processor, such as, for example, a bank of first deposit, over a public and/or private communication network or networks.

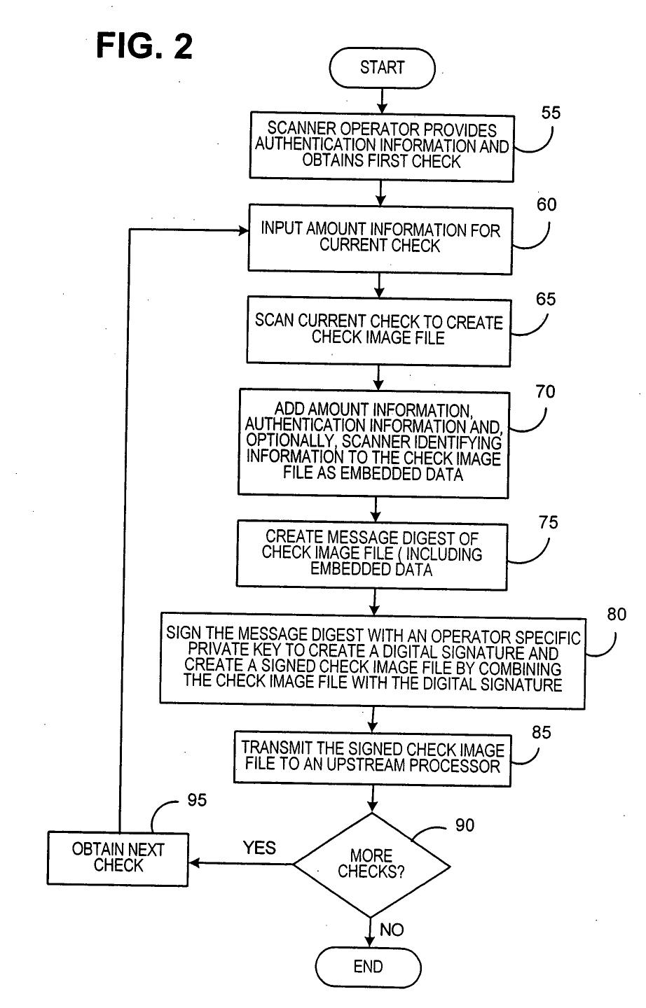

FIG. 2 is a flowchart of a method for processing one or more checks before electronically transmitting the checks to an upstream processor, such as a bank of first deposit for depositing the checks, according to an alternate embodiment of the present invention. The method begins at step 55, wherein the operator of a scanning device as described above provides authentication information to the scanning device and obtains the first check to be processed. Then, at step 60, the operator inputs information indicating the amount for the current check, such as by using a keyboard or other input device provided as part of the scanning device. Next, at step 65, the current check is scanned by the digital scanner of the scanning device to create a check image file. At step 70, the input amount information, the authentication information and, optionally, information identifying the particular scanning device, such as a serial number, is added to the check image file as embedded data.

At step 75, a message digest of the check image file, including the embedded data, is then created. At step 80, the message digest created in step 75 is signed (encrypted) using an operator specific private key to create a digital signature, and a signed check image file is created by combining the check image file, including the embedded data, with the digital signature (the file may also include the public key certificate). As was the case in step 30 of FIG. 1, the private key that is used may instead be a key assigned to the scanning device being used. Next, at step 85, the signed check image file is transmitted to an upstream processor, such as a bank of first deposit. Then, at step 90, a determination is made as to whether there are more checks that need to be processed. If the answer is yes, then, at step 95, the next check is obtained and the method proceeds to step 60 to process that check as described above. If the answer at step 90 is no, meaning all of the checks have been processed, then the method ends. As will be appreciated, the methods of FIG. 1 and FIG. 2 differ in that, in FIG. 2, each signed check image file is transmitted upstream once it is created, whereas in FIG. 1, all of the signed check image files that are created are transmitted at once to the upstream process as part of a digitally signed data element. The latter option is particularly advantageous as there is evidentiary value in knowing, in an unequivocal manner, that a group of checks were received (deposited) at the same time.

As alternative, the process in FIG. 1 may be modified to include a step, after step 85, of creating a hash of the signed check image file and adding it to an ongoing hash file. As a result, when it is determined at step 90 that there are no more checks, the ongoing hash file will be an ongoing hash that includes a hash of each of the signed check image files. Then, the process in FIG. 1 may be further modified to include a step, when the answer in step 90 is no, of creating a signed deposit file using the ongoing hash file in a manner similar to that described in connection with step 45 of FIG. 1 and transmitting the signed deposit file to an upstream processor. This approach is advantageous because less information must be stored on the scanning device to calculate the deposit file hash due to the fact that the signed check image files do not need to be stored while other checks are being processed (as is required in FIG. 1 prior to step 45 being performed).

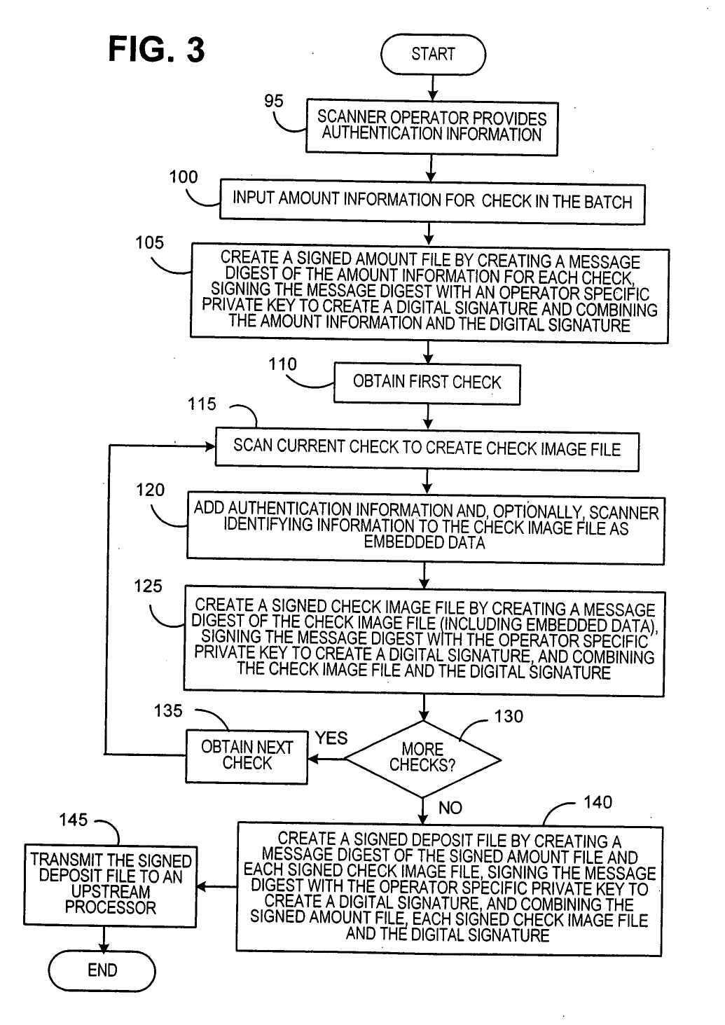

FIG. 3 is a flowchart showing a method of processing one or more checks before the checks are electronically transmitted to an upstream processor, such as a bank of first deposit, according to yet a further alternative embodiment of the present invention. The method begins at step 95, wherein an operator of a scanning device as described above provides authentication information to the scanning device. Next, at step 100, the operator inputs amount information for each of the checks in the batch of checks being processed. As will be appreciated, this may be done by examining each of the physical checks in the batch or by reading the amount information for each check from a list of check amounts previously compiled. At step 105, a signed amount file is created by creating a message digest of the amount information for each check, signing the message digest with an operator specific private key to create a digital signature and combining the amount information for each check and the digital signature in a data file (which may also include the public key certificate). As described above, the private key that is used in the step may alternatively be a private key assigned to the scanning device being used.

At step 110, the first check to be processed is obtained. At step 115, the current check, in this case the first check, is scanned to create a check image file. Next, at step 120, the authentication information that was input and, optionally, information identifying the scanning device is added to the check image file as embedded data. Then, at step 125, a signed check image file is created by creating a message digest of the check image file, including the embedded data, signing the message digest with the operator specific private key (or alternatively a scanning device private key) to create a digital signature, and combining the check image file, including the embedded data, and the digital signature in a data file (which may also include the public key certificate). At step 130, a determination is made as to whether there are additional checks to be processed. If the answer is yes, then, at step 135, the next check is obtained and the method proceeds to step 115 for further processing of the check as described above. If the answer is no at step 130, meaning all of the checks in the batch have been processed, then the method proceeds to step 140.

At step 140, a signed deposit file is created by (i) creating a message digest of a data file consisting of the signed amount file and each signed check image file, (ii) signing the message digest with the operator specific private key (or a scanning device private key) to create a digital signature, and (iii) combining the singed amount file, each signed check image file and the digital signature in a data file. Then, at step 145, the signed deposit file is transmitted to an upstream processor, such as, for example, a bank of first deposit.

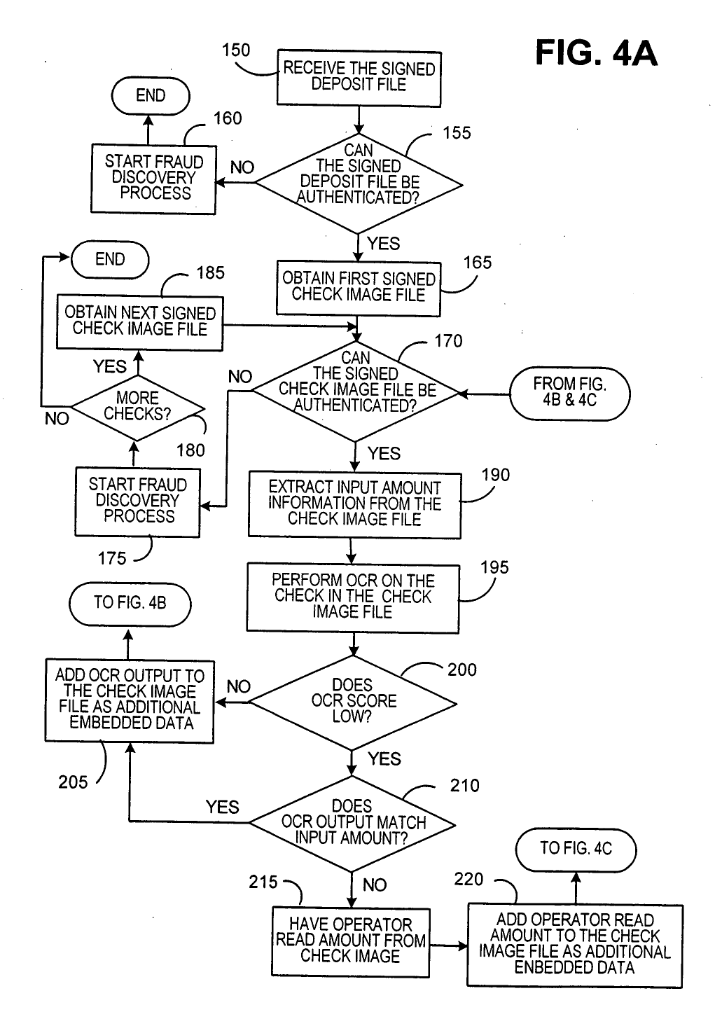

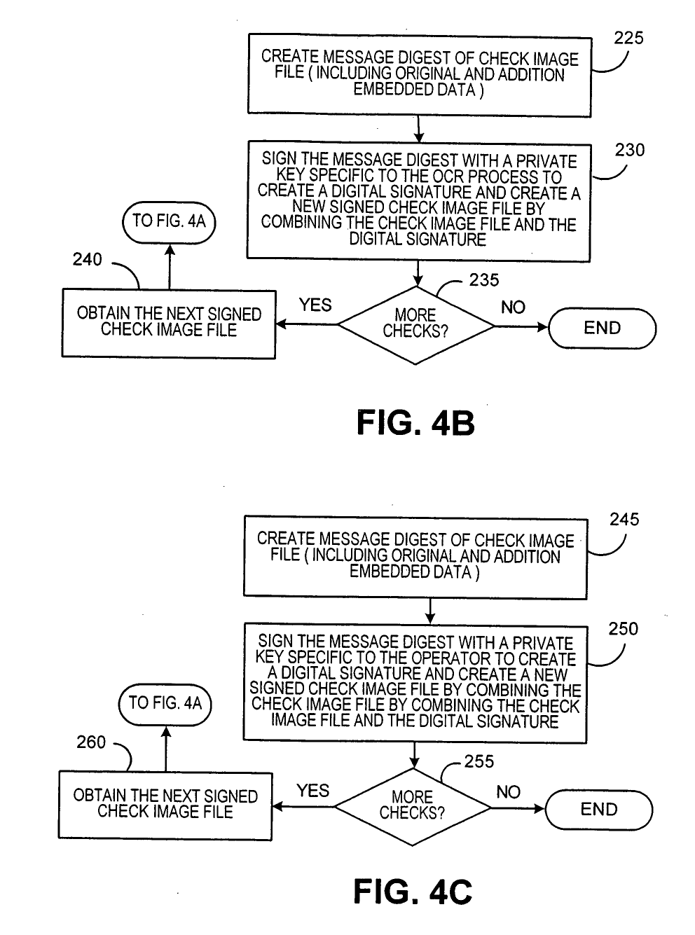

FIGS. 4A, 4B and 4C are flowcharts of a method of further processing the checks that were processed according to the method shown in either FIG. 1 or 2. The method shown in FIGS. 4A, 4B and 4C is performed at a location upstream from the location at which the processing of FIG. 1 or 2 took place, such as at a bank into which the checks are being electronically deposited. If the checks are processed according to the method of FIG. 1, steps 150 and 155 as described below are performed. If, however, the checks are processed according the method of FIG. 2, steps 150 and 155 are omitted.

The method begins at step 150, if appropriate, wherein the signed deposit file is received by the upstream processor, e.g., the bank of first deposit. At step 155, a determination is made as to whether the signed deposit file can be authenticated. As is known, this authentication is performed by (i) obtaining the public key that corresponds to the private key used in the method of FIG. 1, (ii) using the public key to decrypt the digital signature forming part of the signed deposit file and thereby obtain a first message digest, (iii) creating a second message digest of each of the signed check image files forming a part of the signed deposit file using the same algorithm that was used in the method of FIG. 1, and (iv) comparing the two message digests. If they agree, then the signed deposit file is determined to be authentic, and if they do not agree, then the signed deposit file is determined to not be authentic. If the answer at step 155 is no, then, at step 160, the upstream processor begins a fraud discovery or investigation process and the method ends.

If the answer is yes at step 155, meaning that the signed deposit file can be authenticated, then, at step 165, then the first signed check image file is obtained from the signed deposit file. Also, if checks in question have been processed according the method of FIG. 2, then the processing at this stage begins with step 165, as there will be no signed deposit file to consider. In either case, at step 170, a determination is made as to whether the current signed check image file can be authenticated. As will be appreciated, this may be performed in a manner similar to that described in connection with step 155 above using the digital signature of the signed check image and the appropriate public key. If the answer at step 170 is no, then at step 175, the upstream processor starts a fraud discovery or investigation process. Then, at step 180, a determination is made as to whether there are additional checks to be processed. If the answer is no, then the method ends. If, however, the answer at step 180 is yes, then, at step 185, the next signed check image file is obtained and the method proceeds to step 170 for authentication.

If, the answer at step 170 is yes, meaning that the current signed check image file can be authenticated, then the method proceeds to step 190, where the input amount information is extracted from the check image file (this is the amount information that was previously input by the operator of the scanning device). Next, at step 195, optical character recognition (OCR) is performed on the check in the check image file to obtain the amount of the check therefrom. A particular type of software, commonly referred to as courtesy amount recognition (CAR) software and legal amount recognition (LAR) software (CAR/LAR software), is able to obtain from each check image the courtesy amount (which is the numerical dollar amount written on the check) and the legal amount (which is the dollar amount of the check written out in words). CAR/LAR software is well known in the art, and is commercially available from a number of different vendors such as Wausau Financial Systems and A2iA Corp.

As is known, most CAR/LAR software provides a confidence score each time it performs a read operation which indicates a relative confidence, typically expressed as a percentage, in the accuracy of the dollar amount obtained from a check image as a result of the read. Thus, at step 200, a determination is made as to whether the OCR score is below a predetermined threshold value. If the answer at step 200 is no, meaning that the OCR score is sufficiently high, then, at step 205, the OCR output is added to the check image file as additional embedded data (i.e., in addition to the data that was embedded in the method of FIG. 1 or FIG. 2). The name, version number and/or manufacturer of the OCR software may also be added to the check image file as additional embedded data.

If, however, the answer at step 200 is yes, meaning that the score was not high enough, then, at step 210, a determination is made as to whether the OCR output matches the input amount that was extracted at step 190. If the answer is yes, then the method proceeds to step 205, wherein the OCR output is added to the check image file as additional embedded data. Again, the name, version number and/or manufacturer of the OCR software may also be added to the check image file as additional embedded data. Following step 205, the method proceeds to FIG. 4B for further processing as described below. However, if the answer at step 210 is no, meaning that the OCR output does not match the input amount, then, at step 215, an operator at the upstream processor visually reads the amount from the check image. Then, at step 220, the operator read amount is added to the check image file as additional embedded data (in addition to the data embedded in the method of FIG. 1 or FIG. 2). Optionally, operator identifying or authenticating information, such as a PIN, token or biometric information, may also be embedded in the check image file. Following step 220, the method proceeds to FIG. 4C for further processing as described below.

Referring to FIG. 4B, the processing that occurs following step 205 is shown. This is processing that will occur in the event that an OCR output was added to the check image file as additional embedded data. At step 225, a message digest of the check image file, including the original and additional embedded data, is created. Then, at step 230, the message digest is signed (encrypted) with a private key specific to the OCR process/software used in step 195 to create a digital signature. The certificate for this public/private key pair is registered to a specific version of the OCR process/software for reasons that will become apparent below. Then, a new signed check image file is created by combining the check image file, including the original and additional embedded data, and the digital signature (the file may also include the public key certificate). It is significant that the original data is included in the new signed check image file. In this way, the added information can be removed by and upstream processor and the original operator can be validated. This is important for the integrity of the audit trail. At step 235, a determination is made as to whether more checks need to be processed. If the answer is no, then the method ends. If, however, the answer is yes, then, at step 240, the next signed check image file is obtained and the method returns to FIG. 4A at step 170.

Referring to FIG. 4C, a method of further processing the checks when operator read amounts and possibly operator identifying information are added to the check image files as additional embedded data is shown. At step 245, a message digest of the check image file, including the original and additional embedded data, is created. Next, at step 250, the message digest is signed (encrypted) with a private key specific to the operator that read the amount in step 215 to create a digital signature. As noted above, the certificate for this public/private key pair is registered to a specific version of the OCR process/software for reasons that will become apparent below. Next, a new signed check image file is created by combining the check image file, including the original and additional embedded data, and the digital signature (the file may also include the public key certificate). Next, at step 255, a determination is made as to whether more checks need to be processed. If the answer is no, then the method ends. If, however, the answer is yes, then at step 260, the next signed check image file is obtained and the method proceeds to FIG. 4A at step 170.

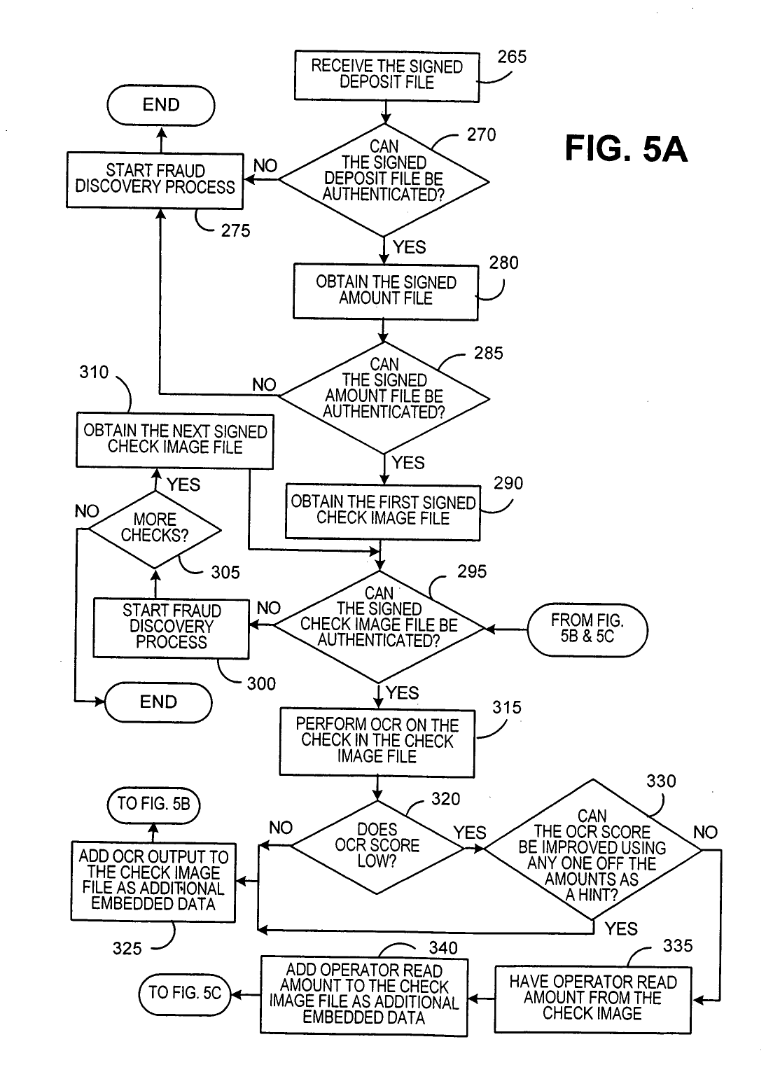

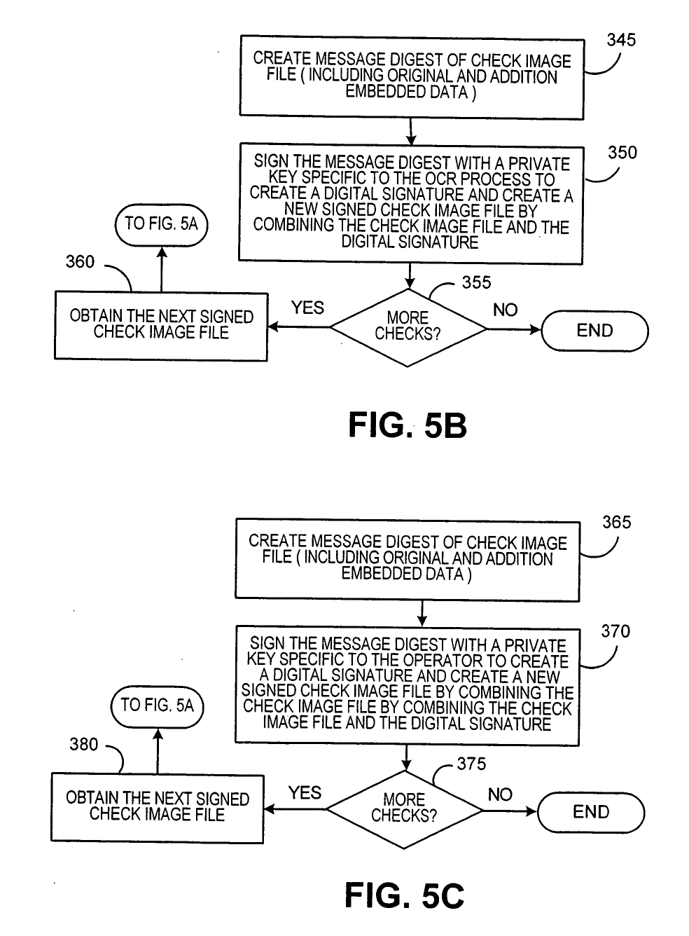

FIG. 5A is a flowchart showing a method for processing checks by an upstream processor such as a bank of first deposit when a plurality of checks have been previously processed according to the method shown in FIG. 3. The method beings at step 265, wherein the signed deposit file created at step 140 of FIG. 3 and transmitted at step 145 of FIG. 3 is received by the upstream processor. Next, at step 270, a determination is made as to whether the signed deposit file can be authenticated in the manner described above in connection with step 155 of FIG. 4A. If the answer at step 270 is no, then at step 275, the upstream processor starts a fraud discovery or investigation process. The process then ends. If, however, the answer at step 270 is yes, then, at step 280, the signed amount file is obtained from the signed deposit file. Then, at step 285, a determination is made as to whether the signed amount file can be authenticated using the digital signature of the signed amount file and the appropriate public key as described elsewhere herein. If the answer is no, then the method proceeds to step 275, wherein the upstream processor starts the fraud discovery or investigation process and the method ends.

If, however, the answer at step 285 is yes, meaning that both the signed deposit file and the signed amount file have been authenticated, then, at step 290, the first signed check image file is obtained from the signed deposit file. At step 295, a determination is made as to whether the signed check image file can be authenticated using the digital signature thereof and the appropriate public key as described elsewhere herein. If the answer at step 295 is no, then, at step 300 the upstream processor starts a fraud discovery or investigation process for the check shown in the current check image file. Then, at step 305, a determination is made as to whether there are more checks in the signed deposit file left to be processed. If the answer is no, the method ends. If, however, the answer is yes at step 305, then, in step 310, the next signed check image file is obtained from the singed deposit file and the method returns to step 295 for further processing as described herein.

If the answer at step 295 is yes, meaning that the signed check image file in question can be authenticated, then, at step 315, optical character recognition (OCR) preferably using CAR/LAR software is performed on the check in the check image file. At step 320, a determination is made as to whether the OCR score is lower than a predetermined threshold. If the answer at step 320 is no, then, at step 325, the OCR output is added to the check image file as additional embedded data. The name, version number and/or manufacturer of the OCR software may also be added to the check image file as additional embedded data. If, however, the answer at step 320 is yes, meaning that the OCR score was low, then, at step 330, a determination is made as to whether or not the OCR score can be improved to a level above the predetermined threshold using any one of the amounts contained in the amount file as a hint. Preferably, step 330 is performed as described in co-pending application Ser. No. 11/252,044, filed on Oct. 17, 2005 and entitled “Method for Remote Check Capture,” assigned to the Assignee hereof, the disclosure of which is hereby incorporated by reference. If the answer at step 330 is yes, meaning that the OCR score has been improved such that it exceeds the predetermined threshold value, then the method proceeds to step 325, wherein the OCR output is added to the check image file as additional embedded data. Again, the name, version number and/or manufacturer of the OCR software may also be added to the check image file as additional embedded data. If, however, the answer at step 330 is no, meaning that none of the amounts contained in the amount file was able to cause the OCR score to be improved above the predetermined threshold level, then, at step 335, wherein an operator visually reads an amount from the check image. Then, at step 340, the operator read amount and, optionally, operator identifying information is added to the check image file as additional embedded data.

Referring to FIG. 5B, the processing that occurs following step 325 is shown. This is processing that will occur in the event that an OCR output was added to the check image file as additional embedded data. Again, for the reasons noted above, it is significant that the original data is included in the new signed check image file. At step 345, a message digest of the check image file, including the original and additional embedded data, is created. Then, at step 350, the message digest is signed (encrypted) with a private key specific to the OCR process/software used in step 315 to create a digital signature. Then, also at step 350, a new signed check image file is created by combining the check image file, including the original and additional embedded data, and the digital signature. At step 355, a determination is made as to whether more checks need to be processed. If the answer is no, then the method ends. If, however, the answer is yes, then, at step 360, the next signed check image file is obtained and the method returns to FIG. 5A at step 295.

Referring to FIG. 5C, a method of further processing the checks when operator read amounts and possibly operator identifying information are added to the check image files as additional embedded data is shown. At step 365, a message digest of the check image file, including the original and additional embedded data, is created. Next, at step 370, the message digest is signed (encrypted) with a private key specific to the operator that read the amount in step 335 to create a digital signature. Next, also at step 370, a new signed check image file is created by combining the check image file, including the original and additional embedded data, and the digital signature. Next, at step 375, a determination is made as to whether more checks need to be processed. If the answer is no, then the method ends. If, however, the answer is yes, then at step 380, the next signed check image file is obtained and the method proceeds to FIG. 5A at step 295.

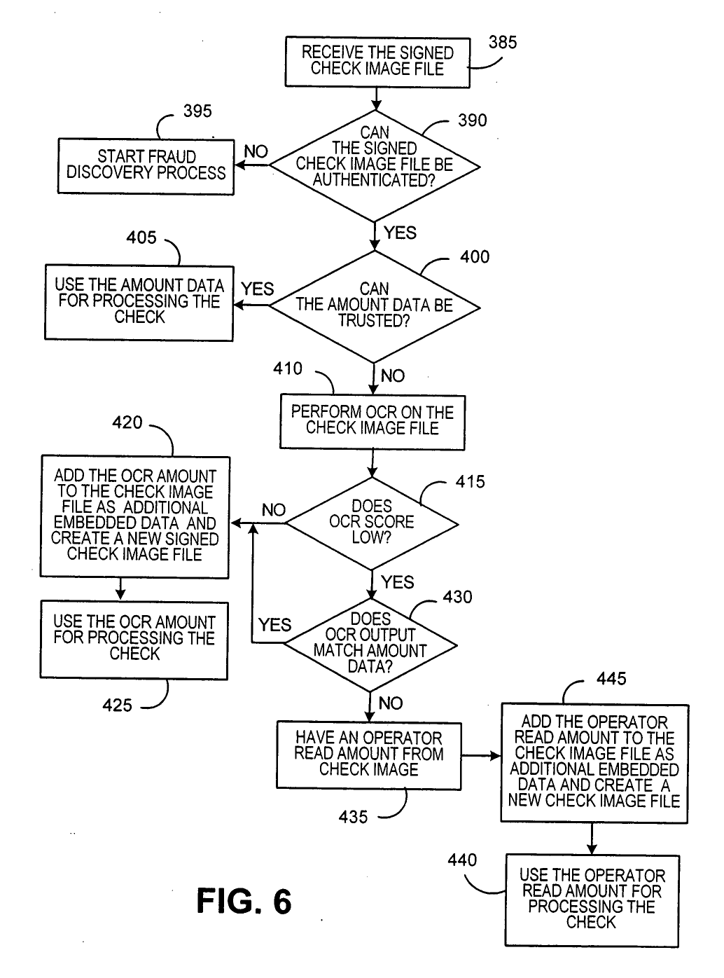

FIG. 6 is a flowchart showing a method of processing a signed check image file as created in the method shown in FIGS. 4A, 4B and 4C or FIGS. 5A, 5B, and 5C that may be performed by a further upstream processor. Such an upstream processor may include, for example, a check clearing entity such as a private check clearing house or the Federal Reserve.

The method begins at step 385, wherein the signed check image file to be processed is received by the upstream processor. Next, at step 390, a determination is made as to whether the signed check image file can be authenticated using the digital signature contained therein and the appropriate corresponding public key as described elsewhere herein. If the answer at step 390 is no, then, at step 395, the upstream processor begins a fraud discovery or investigation process for the check in the signed check image file. If, however, the answer at step 390 is yes, then, at step 400, a determination is made as to whether the amount data contained in the signed check image file can be trusted. Preferably, the determination at step 400 is based upon a set of one or more business rules established by the particular upstream processor. In essence, these business rules are established to determine whether or not a new OCR should be performed on the check image at this stage based upon whether, as established by this particular upstream processor, the OCR or other operator input that was performed with respect to the signed check image file by a downstream processor should be trusted. In other words, at step 400, this upstream processor is, on a signed check image file by signed check image file basis, making an educated choice as to whether to again OCR the check image in question. This is beneficial because, as will be appreciated by those of skill in the art, OCR processing is expensive and time and resource consuming. The determination made in step 400 may be based on a number of different factors such as, without limitation, the identity of the downstream processor, i.e., bank, that provided the signed check image file, the identity of the operator that input information relating to the signed check image file, and/or the identity of the software package and/or version thereof that was used in a downstream process to perform OCR on the check image and thereby add data to the signed check image file. The particular information used to make this decision in each case is, as described elsewhere herein, may be provided as part of the embedded data included in the check image file, or alternatively, as data included with the check image file. In one particular embodiment, the determination made in step 400 may be based on the public key that is used to authenticate the signed check image file (obtained form the public key certificate included therewith or obtained from a certificate authority), in which case it is determined wither the public key is specific to a trusted operator or OCR process (a databases may be maintained for this purpose).

If the answer at step 400 is yes, meaning that the amount data in the signed check image file can be trusted according to the predetermined business rule or rules, then, at step 405, the amount data from the signed check image file is used for processing the check by the upstream processor. If, however, the answer at step 400 is no, meaning that it has been determined that the amount data cannot be trusted for the signed check image file, then, at step 410, OCR is performed by the upstream processor on the check in the check image file. Next, at step 415, a determination is made at step 415 as to whether the OCR score is below a predetermined threshold level. If the answer at step 415 is no, then, at step 420, the OCR amount is added to the check image file as additional embedded data and a new signed check image file is created by generating a message digest of the check image file (including the additional embedded data), signing the message digest with a private key of the upstream processor (in particular of the OCR process used by the upstream processor) to create a digital signature, and combining the check image file and the digital signature. The name, version number and/or manufacturer of the OCR software may also be added to the check image file as additional embedded data. Then, at step 425, the OCR amount generated in step 410 is used for processing the check by the upstream processor.

If, however, the answer at step 415 is yes, then, at step 430, a determination is made as to whether the OCR output matches the amount data contained in the new signed check image file (i.e., the OCR or operator input amount provided in the downstream process, whichever the case may be). If the answer at step 430 is yes, then the method returns to step 420. If, however, the answer at step 430 is no, then, at step 435, an operator visually reads the amount from the check image in the signed check image file. Then, at step 440, the operator read amount is added to the check image file as additional embedded data and a new signed check image file is created in the manner described in connection with step 420 (except, preferably, a private key of the operator is used). Then, at step 445, the operator read amount is used for processing the check by the upstream processor. It should be noted that the concept shown in FIG. 6 may be extended to determining whether other acts performed downstream, such as the reading of MICR lines o rather image based security checks, should be trusted.

While preferred embodiments of the invention have been described and illustrated above, it should be understood that these are exemplary of the invention and are not to be considered as limiting. Additions, deletions, substitutions, and other modifications can be made without departing from the spirit or scope of the present invention. Accordingly, the invention is not to be considered as limited by the foregoing description but is only limited by the scope of the appended claims.

What is claimed is:

1. A method of processing a check, comprising:
receiving authentication information;
receiving amount information indicating an amount of said check;
creating a check image file, said check image file including an electronic image of said check;
adding at least said authentication information and said amount information to said check image file as embedded data to create a new check image file; and
creating a signed check image file, said signed check image file including said new check image file and a digital signature of said new check image file created using a private key.

2. The method according to claim 1, wherein said authentication information and said amount information are received from an operator.

3. The method according to claim 2, wherein said private key is specific to said operator.

4. The method according to claim 1, wherein said private key is specific to a device used to generate said electronic image.

5. The method according to claim 1, wherein said step of creating said check image file includes generating said electronic image.

6. The method according to claim 1, further comprising transmitting said signed check image file to an upstream processor.

7. The method according to claim 4, wherein said upstream processor is a bank of first deposit for said check.

8. The method according to claim 1, further comprising creating a signed deposit file, said signed deposit file including a deposit file and a digital signature of said deposit file, wherein said deposit file includes said signed check image file and one or more additional signed check image files, each of said one or more additional signed check image files being created using a corresponding one of one or more additional checks, and wherein said digital signature of said deposit file is created using said private key.

9. The method according to claim 1, wherein said adding step also includes adding device information to said check image file as embedded data to create said new check image file, said device information identifying a device used to generate said electronic image.

10. A method of processing a plurality of checks, comprising:
receiving authentication information;
creating a signed amount file, said signed amount file including an amount file and a digital signature of said amount file created using a private key; said amount file including amount information received from said operator for each of said checks;
creating a check image file for each of said checks, each said check image file including an electronic image of a respective one of said checks;
adding at least said authentication information to each said check image file as embedded data to create a respective new check image file for each of said checks;
creating a signed check image file for each said new check image file, wherein each said signed check image file includes a respective new check image file and a digital signature of the respective new check image file created using a private key; and
creating a signed deposit file, said signed deposit file including said signed amount file and each said signed check file and a digital signature of said signed amount file and each said signed check file created using said private key.

11. The method according to claim 10, wherein said authentication information is received from an operator.

12. The method according to claim 11, wherein said private key is specific to said operator.

13. The method according to claim 9, wherein said private key is specific to a device used to generate each said electronic image.

14. The method according to claim 9, wherein said step of creating each said check image file includes generating each said electronic image.

15. The method according to claim 9, further comprising transmitting said signed deposit file to an upstream processor.

16. The method according to claim 13, wherein said upstream processor is a bank of first deposit for said checks.

17. The method according to claim 9, wherein said adding step also includes adding device information to each said check image file as embedded data to create each said new check image file, said device information identifying a device used to generate each said electronic image.

18. A method of processing a check, comprising:
receiving a check image file, said check image file including an electronic image of said check and amount information indicating an amount of said check;
performing OCR on the electronic image using an OCR process to obtain an OCR amount for said check;
if said OCR amount matches said amount information, creating a first new signed check image file using at least OCR amount; and
if said OCR amount is not trustworthy and does not match said amount information, creating a second new signed check image file using at least second amount information read by an operator.

19. The method according to claim 18, wherein said step of creating a first new signed check image file includes adding said OCR amount to said check image file as embedded data to create a first new check image file, wherein said first new signed check image file includes said first new check image file and a digital signature of said first new check image file created using a private key specific to said OCR process, and wherein said step of creating a second new signed check image file includes adding said second amount information to said check image file as embedded data to create a second new check image file, wherein said second new signed check image file includes said second new check image file and a digital signature of said second new check image file created using a private key specific to said operator.

20. The method according to claim 18, wherein said OCR amount has a confidence score, wherein said OCR amount is trustworthy if said confidence score exceeds a predetermined threshold level, and wherein said OCR amount is not trustworthy if said confidence score does not exceed said predetermined threshold level.

21. The method according to claim 18, said check image file being part of a signed check image file including said check image file and a digital signature of said check image file, wherein said steps of said method are performed only if said signed check image file can be authenticated, and wherein a fraud investigation is commenced for said check if said signed check image file cannot be authenticated.

22. The method according to claim 19, wherein said step of adding said second amount information to said check image file also includes adding information identifying said operator to said check image file as embedded data to create said second new check image file.

23. A method of processing a check, comprising:
receiving a deposit file, said deposit file including an amount file and a plurality of check image files, said amount file including a plurality of amounts corresponding to a plurality of checks being deposited, said check being one of said plurality of checks, said check image files including a check image file for said check, said check image file for said check including an electronic image of said check;
performing OCR on the electronic image using an OCR process to obtain an OCR amount for said check;
if said OCR amount is trustworthy, creating a first new signed check image file using at least said OCR amount;
if said OCR amount is not trustworthy but a second OCR amount that is trustworthy can be obtained by re-performing OCR on the electronic image using said OCR process and one of said amounts, creating a second new signed check image file using at least said second OCR amount; and
if said OCR amount is not trustworthy and if a second OCR amount that is trustworthy cannot be obtained, creating a third new signed check image file using at least second amount information read by an operator.

24. The method according to claim 23, wherein said step of creating a first new signed check image file includes adding said OCR amount to said check image file as embedded data to create a first new check image file, wherein said first new signed check image file includes said first new check image file and a digital signature of said first new check image file created using a private key specific to said OCR process, wherein said step of creating a second new signed check image file includes adding said second OCR amount to said check image file as embedded data to create a second new check image file, wherein said second new signed check image file includes said second new check image file and a digital signature of said second new check image file created using the private key specific to said OCR process, and wherein said step of creating a third new signed check image file includes adding said second amount information to said check image file as embedded data to create a third new check image file, wherein said third new signed check image file includes said third new check image file and a digital signature of said third new check image file created using a private key specific to said operator.

25. The method according to claim 23, wherein said OCR amount has a first confidence score and said second OCR amount has a second confidence score, wherein said OCR amount is trustworthy if said confidence score exceeds a predetermined threshold level, wherein said OCR amount is not trustworthy if said confidence score does not exceed said predetermined threshold level, wherein said second OCR amount is trustworthy if said second confidence score exceeds said predetermined threshold level, and wherein said second OCR amount is not trustworthy if said second confidence score does not exceed said predetermined threshold level.

26. The method according to claim 23, said deposit file being part of a signed deposit file including a digital signature of said deposit image file and said amount file being part of a signed amount file including a second digital signature of said amount file, wherein said steps of said method are performed only if said signed deposit file and said signed amount file can each be authenticated, and wherein a fraud investigation is commenced if either said signed deposit file or said signed amount file cannot be authenticated.

27. The method according to claim 24, wherein said step of adding said second amount information to said check image file also includes adding information identifying said operator to said check image file as embedded data to create said third new check image file.

28. A method of processing a check, comprising:
receiving a check image file, said check image file including an electronic image of said check and amount data indicating an amount of said check;
determining whether said amount data is to be trusted using information associated with said check image file and one or more pre-defined rules;
if it is determined that said amount data is to be trusted, using said amount data to process said check;
if it is determined that said amount data is not to be trusted, performing OCR on said electronic image to obtain an OCR amount and using said OCR amount to process said check.

29. The method according to claim 28, said amount data having been generated by one of an OCR process and an operator, wherein said information associated with said check image file relates to an identity of one of said OCR process and said operator.

30. The method according to claim 29, wherein said check image file is part of a signed check image file including a digital signature created using a private key of one of said OCR process and said operator, and wherein said information associated with said check image file that is used to determine whether said amount data is to be trusted includes a public key corresponding to said private key.

31. The method according to claim 28, wherein said information associated with said check image file is embedded in or included with said check image file.
